(19) United States
(12) Patent Application Publication
(10) Pub. No.: US 2003/0174630 A1
(43) Pub. Date: Sep. 18, 2003

(54) Integrated optical device and wavelength variation cancellation method

(76) Inventor: Masataka Izawa, Tsurugashima-shi (JP)

Correspondence Address: YOUNG & THOMPSON, 745 SOUTH 23RD STREET 2ND FLOOR, ARLINGTON, VA, 22202

(21) Appl. No.: 10/359,152

(22) Filed: Feb. 6, 2003

(30) Foreign Application Priority Data
Feb. 6, 2002 (JP) P2002-29979

(51) Int. Cl. G11B 3/00

(52) U.S. Cl. 369/99

(57) ABSTRACT

This invention provides an integrated optical device, which is used in an optical pickup apparatus that receives light reflected by an optical medium, is provided with a grating 5 that creates both guided light and transmitted light from the reflected light and that is layered with a light guide that transmits the guided light; and wherein the grating 5 is provided with a first optimized device that is optimized for a first wavelength of said reflected light; a second optimized device that is optimized to a wavelength that is longer than the first wavelength of the reflected light; and a third optimized device that is optimized to a wavelength that is shorter than the first wavelength of the reflected light.

### BACKGROUND OF THE INVENTION

1. Field of the Invention

This invention relates to the field of integrated optical devices that are used in an optical pickup apparatus that optically reproduces data that are recorded on a recording medium such as a CD (Compact Disc), LDV (Laser Vision Disc), DVD (Digital Versatile Disc) or the like, or optically records data on a recoding medium.

2. Description of the Related Art

Integrated optical devices that are used in an optical pickup apparatus. The integrated optical device is an integrated optical device for an optical pickup apparatus that uses a photodetector having a first optical receiving device and second optical-receiving device formed on a semiconductor substrate, and that integrates a buffer layer, a light guide, SOG (Spin ON Glass) layer, an optical-coupling (grating) layer, and an out-path/return-path separating film on this photodetector by a semiconductor manufacturing process. Also, this integrated optical device is constructed such that the first optical-receiving device is placed directly below the grating, an incline is formed in the buffer layer surrounding the second optical-receiving device, and the thickness of the buffer layer on top of the second optical-receiving device is thinner than the other layers.

However, in prior optical pickup apparatuses, variation in the wavelength of the semiconductor laser was not taken into consideration.

In other words, it is known that as the temperature surrounding the semiconductor laser changes, the optical path length of the semiconductor laser changes, and thus the wavelength of the emitted laser varies. In prior integrated optical devices, there was a problem in that the grating, which is the optical coupling means, was only designed for one wavelength, and variation on the wavelength of the incident light was not taken into consideration.

As a result, in prior optical pickup apparatuses, when the temperature surrounding the optical pickup apparatus changes, the input coupling efficiency of the grating changes, and the focus-error signal that calculates the receive signal, which is light that has passed through the grating and converted to an electric signal, deteriorates and it becomes impossible for the focus servo to function properly.

### SUMMARY OF THE INVENTION

The object of this invention is to suppress deterioration of the focus-error signal, which detects the location of the focal point of the light irradiated on the optical-data-recording medium, by reducing the change in intensity of the guided light after passing through the grating, or optical-coupling means of an integrated optical device, even when the wavelength of the light passing through the grating varies.

The above object of the present invention can be achieved by an integrated optical device of the present invention. The integrated optical device, which is used in an optical pickup apparatus that receives light reflected by an optical medium, is provided with an optical coupling device that creates both guided light and transmitted light from said reflected light and that is layered with a light guide device that transmits said guided light; and wherein the optical coupling device is provided with a first optimized device that is optimized for a wavelength of said reflected light; a second optimized device that is optimized to a wavelength that is longer than said wavelength of said reflected light; and a third optimized device that is optimized to a wavelength that is shorter than said wavelength of said reflected light.

According to the present invention, the optical coupling or grating is formed in a plurality of devices, and the grating pattern of each of the devices is optimized for light of a different wavelength. Therefore, the guided light that is created by the gratings of each device is created as guided light whose reflected light has wavelengths with a good grating-pitch period and coupling efficiency. In this way, the guided light that is created by each of the grating devices spread through the same light guide. When this happens, since the grating patterns are formed by multiple kinds of gratings, changes in the ratio of guided light to transmitted light is kept within an allowable small amount that has very little effect on the function of the integrated optical device, even when the wavelength of the reflected light varies.

In one aspect of the present invention can be achieved by the integrated optical device of the present invention. The integrated optical device, which is used in an optical pickup apparatus that receives light reflected by an optical medium, is provided with an optical coupling device that creates both guided light and transmitted light from the reflected light and that is layered with a light guide device that transmits the guided light; and wherein the optical coupling device is provided with a first optimized device that is optimized for a wavelength of said reflected light; a second optimized device that is optimized to a plurality of wavelength that is longer than the wavelength of the reflected light; and a third optimized device that is optimized to a plurality of wavelength that is shorter than the wavelength of the reflected light.

According to the present invention, the grating pattern, which is the optical-coupling means, comprises a plurality of patterns that correspond to variations in the wavelengths of the light reflected from the optical-data recording medium, so of the light that is reflected from the optical-data recording medium, the guided light that is created by the optical-coupling means is created at constant proportions even when variations in wavelength of the reflected light occur.

In another aspect of the present invention can be achieved by the integrated optical device of the present invention. The integrated optical device of the present invention, wherein there is a plurality of the first, second and third optimized devices of the optical coupling device for the reflected light arranged such that adjacent devices differ from each other.

According to the present invention, the grating pattern, which is the optical-coupling means, is divided in the direction of the principal axis in which the guided light proceeds, and each divided device comprises a plurality of patterns that correspond to variations in the wavelength of the reflected light, so of the light that is reflected from the optical-data recording medium, the guided light that is created by the optical-coupling means is created at nearly constant proportions even when variations in wavelength of the reflected light occur.

In further aspect of the present invention can be achieved by the integrated optical device of the present invention. The integrated optical device of the present invention, wherein the first, second and third devices of the optical coupling device for the reflected light are formed in the same layer.

In further aspect of the present invention can be achieved by the integrated optical device of the present invention. The integrated optical device of the present invention, wherein the integrated optical device is formed on a semiconductor substrate and is further provided with: a first light-receiving device of receiving the transmitted light; and a second light-receiving device of receiving the light that is emitted from the light guide for the guided light toward the side of the semiconductor substrate, and is a device for detecting the focal-point position for the light shown on the optical media.

According to the present invention, the light reflected from the optical-data recording medium travels the optical path through the optical-coupling means, light guide, first optical receiving means and second optical receiving means, where the optical-coupling means, light guide, first optical receiving means and second optical receiving means are integrated on a semiconductor substrate, and manufactured easily by a semiconductor manufacturing process in order to reduce manufacturing cost. Also, the grating pattern, which is the optical-coupling means, comprises a plurality of types of gratings, so even when the wavelength of the reflected light varies, the proportion of guided light to transmitted light is kept to small allowable changes that have nearly no effect on the function of the integrated optical device.

In further aspect of the present invention can be achieved by the integrated optical device of the present invention. The integrated optical device of the first and second light-receiving devices are formed in the same layer.

According to the present invention, the light reflected from the optical-data recording medium travels the optical path through the optical-coupling means, light guide, first optical receiving means and second optical receiving means, and, the optical-coupling means, light guide, first optical receiving means and second optical receiving means are integrated on a semiconductor substrate, and manufactured easily by a semiconductor manufacturing process in order to reduce manufacturing cost.

The above object of the present invention can be achieved by a wavelength variation cancellation method of the present invention. The wavelength variation cancellation method of reducing intensity changes in the signal for detecting focal-point position that occur due to changed in the wavelength of the light reflected by an optical medium and characterized by using a combination of; light that passed trough an optical coupling device that is optimized to a wavelength of the reflected light; light that passed through an optical coupling device that is optimized to a wavelength longer than the wavelength of the reflected light; and light that passed through an optical coupling device that is optimized to a wavelength shorter than the wavelength of the reflected light to generate a signal for detecting the focal-point position.

According to the present invention, the optical coupling or grating is formed in a plurality of devices, and the grating pattern of each of the devices is optimized for light of a different wavelength. Therefore, the guided light that is created by the gratings of each device is created as guided light whose reflected light has wavelengths with a good grating-pitch period and coupling efficiency. In this way, the guided light that is created by each of the grating devices spread through the same light guide. When this happens, since the grating patterns are formed by multiple kinds of gratings, changes in the ratio of guided light to transmitted light is kept within an allowable small amount that has very little effect on the function of the integrated optical device, even when the wavelength of the reflected light varies.

### BRIEF DESCRIPTION OF THE DRAWINGS

FIG. 1 is a pictorial drawing of the return optical path of the entire apparatus of this invention.

FIG.2A is a plan view of an integrated optical device.

FIG.2B is a cross-sectional view of the section X1-X2 in FIG. 2A.

FIG.3 is a drawing showing the grating of a first embodiment of the invention.

FIG.4A and FIG.4B are drawings showing the focus-error signal of the first embodiment of the invention.

FIG.5 is a drawing showing the optical path when the disc is near.

FIG.6 is a drawing showing the optical path when in focus.

FIG.7 is a drawing showing the optical path when the disc is far.

FIG.8 is a drawing showing the grating of a second embodiment of the invention.

FIG.9 is drawing showing the focus-error signal (no variation in the wavelength).

FIG. 10A is a drawing showing the focus-error signal (there is variation in the wavelength, ë−ëΔ).

FIG. 10B is a drawing showing the focus-error signal (there is variation in the wavelength, ë+ëA).

FIG. 11 is a drawing showing the prior grating.

FIG. 12 is a drawing showing the pattern of a cross device of the integrated optical device.

FIG. 13 is a drawing showing the efficiency of guided light (wavelength ë).

FIG. 14 is a drawing showing the efficiency of guided light (wavelength ë−ëΔ).

FIG. 15 is a drawing showing the efficiency of guided light (wavelength ë−ëΔ, incident angle è+èΔ).

FIG. 16 is a drawing explaining the appearance of the grating pitch.

FIG. 17 is a drawing explaining the appearance of the grating pitch.

### DESCRIPTION OF THE PREFERRED EMBODIMENTS

A first embodiment of the integrated optical device of this invention will be explained below.

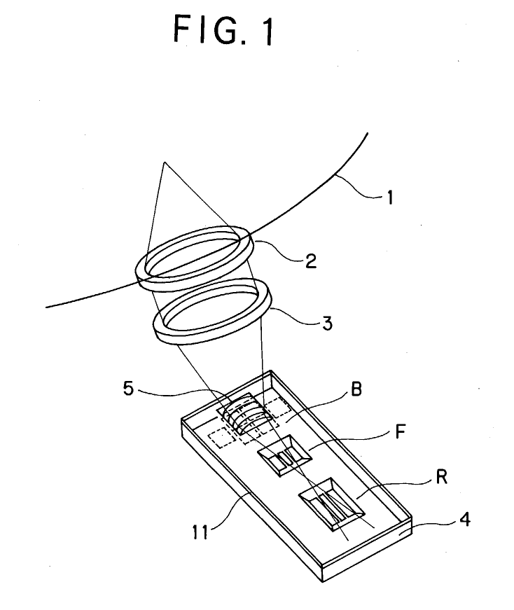

FIG. 1 is a pictorial drawing of an entire optical pickup apparatus that includes the integrated optical device of this embodiment, and it shows only the return optical path of a semiconductor laser beam that is shown on to an optical disc 1. (The light source for the semiconductor laser, and the method of driving the objective lens use well know technology and are not shown in the figure.) The light reflected from the optical disc 1 passes through the objective lens 2, then passes through a collimator lens 3 and reaches the grating 5 that is formed in the integrated optical device 4. Directly underneath the grating 5, there is a light-receiving element B, and part of the light enters the light-receiving element and converted to an electric signal. Other light travels along the light guide 11 until it reaches a light-receiving element F and is converted to an electric signal, and still other light is travels along the light guide until it reaches a light-receiving element R.

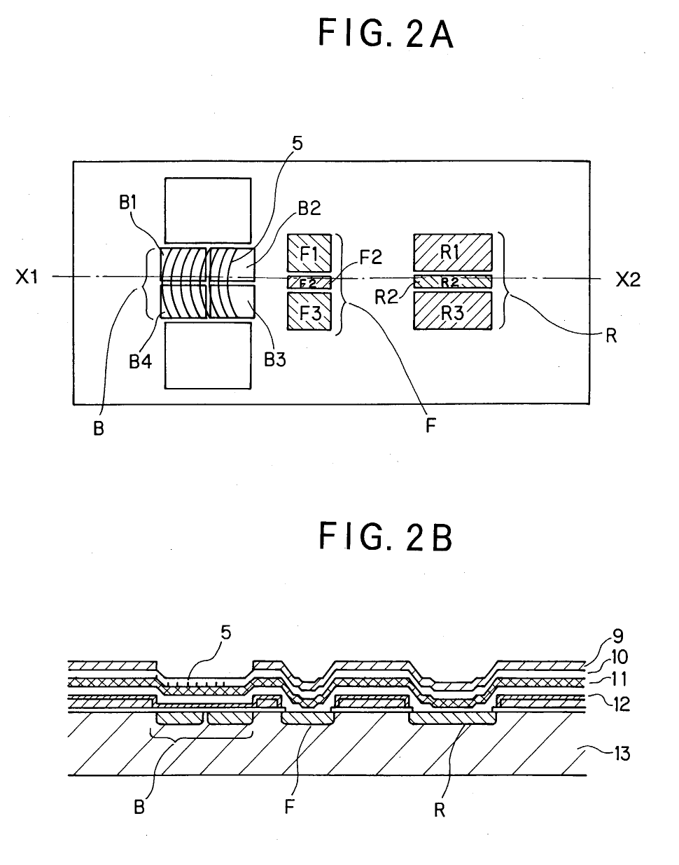

FIG. 2A is a plan view of the integrated optical device 4. Directly underneath the grating 5 there is the light-receiving element B, and this light-receiving element B is divided into light-receiving element B1, light-receiving element B2, light-receiving element B3 and light-receiving element B4. Also, of the light that passes through grating 5, there is other light that does not go toward the light-receiving element B, but enters the light guide 11 and travels until it reaches the light-receiving element F, and there is other light that continues to travel along the light guide 11 until it reaches the light-receiving element R.

As shown in FIG. 2A, light-receiving element F comprises light-receiving elements F1, F2 and F3, and light-receiving element R comprises light-receiving elements R1, R2 and R3.

FIG. 2B is a cross-sectional view of the device X1-X2 of the integrated optical device shown in FIG. 2A. Integrated on the semiconductor substrate, where a first light-receiving device B, second light-receiving device F and third light-receiving device R are formed, there is a bottom cladding layer 12, a light guide 11 that is formed on the bottom cladding layer 12 that lets laser light pass through and transmits the laser light, a grating 5 that is formed on the light guide 11 and functions as an optical-coupling means that separates the laser light into transmitted light and guided light, a top cladding layer 10 that is formed on top of the grating 5, and a protective layer 9. The top cladding layer 10 and bottom cladding layer 12 are formed out of SOG (Spin On Glass), and the light guide is made out of SiO2. Also, the protective layer is made of Al, however, as can be clearly seen from FIG. 2B, there is no protective layer 9 on top of the grating 5. This is because the role of the protective layer 9 is to prevent unnecessary light from the outside from entering into the integrated optical device, therefore all of the light entering the integrated optical device enters from the top of the grating 5.

The grating 5 is made of 0.10 μm thick TiO2, and together with the light guide 11, makes up the grating coupler. Most of the light that enters the grating coupler is transmitted downward and part is transmitted as guided light by the light guide 11. This king of grating 5 inputs and couples the light returning from the optical disc in the light guide 11, so the grating period must be set about the same or less than the wavelength of the laser light used.

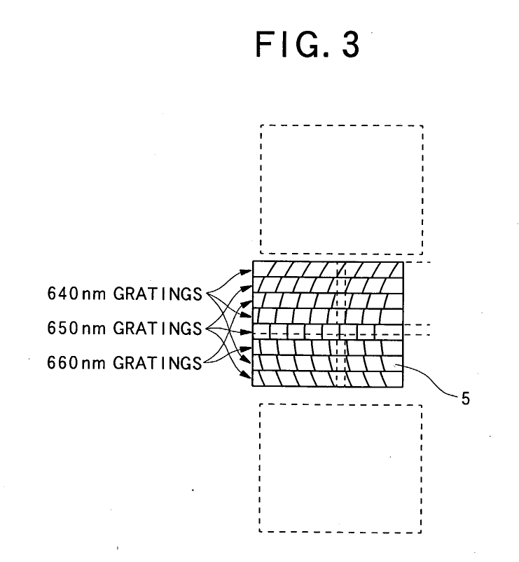

As shown in FIG. 3, in this embodiment, the grating 5 space has eight strip-shaped areas that run in the direction of the center line O, and the grating period of adjacent areas are set such that they change. In other words, there is a grating that has a period optimized for a wavelength of 540 nm, a grating that has a period optimized for a wavelength of 650 nm, and a grating that has a period optimized for a wavelength of 660 nm that are set such that they alternate. The areas that are optimized for each wavelength are each arranged lengthwise to the left and right in FIG. 3. In the example shown in FIG. 3, areas corresponding to the design wavelength value is 650 nm, and the wavelengths around it, 640 nm and 660 nm, are formed on the grating 5.

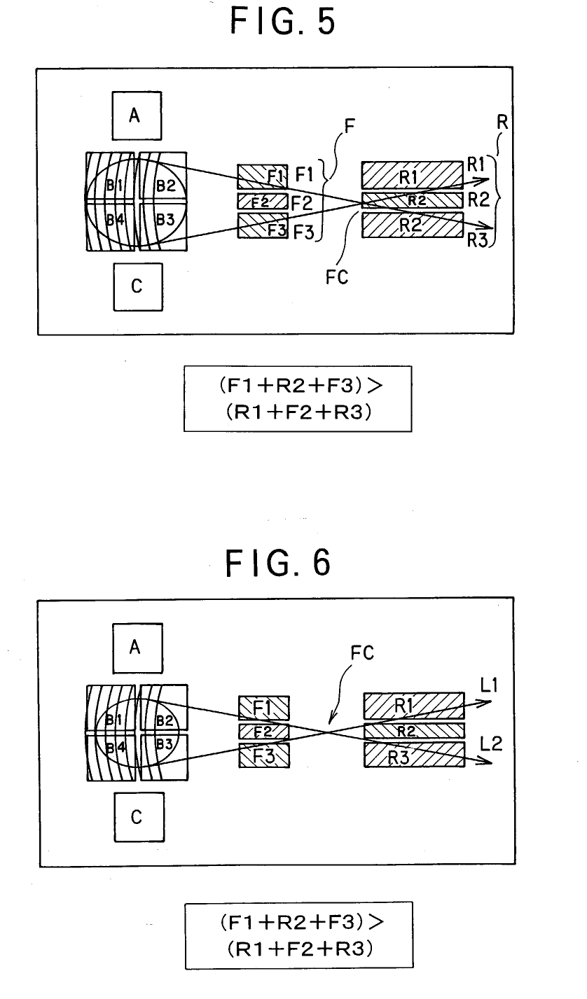

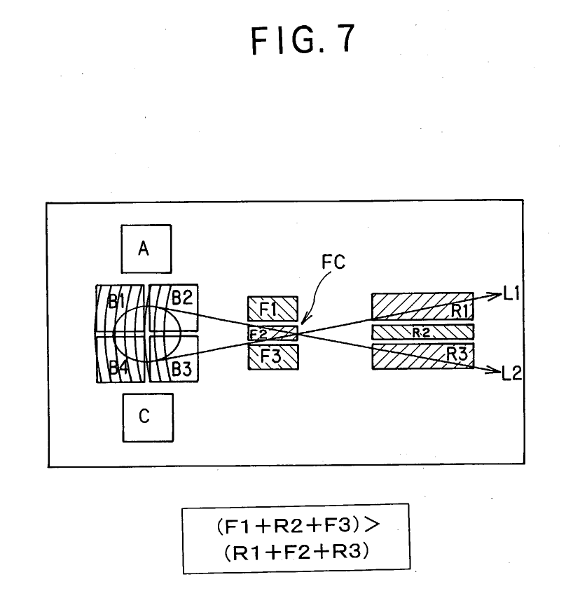

Next, FIG. 5, FIG. 6 and FIG. 7 will be used to explain the method of deriving the focus-error signal from the light-receiving elements F, R. FIG. 5, FIG. 6 and FIG. 7 are plan views of the integrated optical device 4 and show how the light is transmitted through the light guide 11. Of these, FIG. 6 is a drawing showing the optical path of transmission when focal point of the light irradiated on the optical-recording medium is in focus.

When in focus, part of the light reflected from the optical disc travels in the light guide until it reaches light-receiving elements F1, F2 and F3, however, the remaining light travels further in the light guide and comes together at the optical-path intersecting area FC just before the light-receiving element R, and after that enters the light-receiving elements R1, R2 and R3. The light-receiving elements F1, F2 and F3 and R1, R2 and R3 are conversion elements that convert light to electricity, and the focus-error signal is found from (F1+R2+F3)−(R1+F2+R3). FIG. 6 shows the course of the reflected light when the optical spot on the optical disc 1 is a minimum, and so (F1+R2+F3)−(R1+F2+R3) is equal to 0.

When the objective lens moves from the state shown in FIG. 6 toward the disc 1, the position of the focal point FC moves to the side of the light-receiving element R, as shown in FIG. 5, so the intensity of light received by light-receiving element F becomes larger than that received by light-receiving element R. Therefore, (F1+R2+F3) is greater than (R1+F2+R3).

Moreover, when the objective lens moves from the state shown in FIG. 6 away from the disc 1, the position of the focal point FC moves to the side of the light-receiving element F, as shown in FIG. 7, so the intensity of light received by light-receiving element R becomes larger than that received by light-receiving element F. Therefore, (F1+R2+F3)<(R1+F2+R3). In this way, based on the focus-error signal, the distance between the optical disc 1 and objective lens 2 is optimized, or in other words, the position of the objective lens is constantly adjusted such that (F1+R2+F3)=(R1+F2+R3) (not shown in the figures).

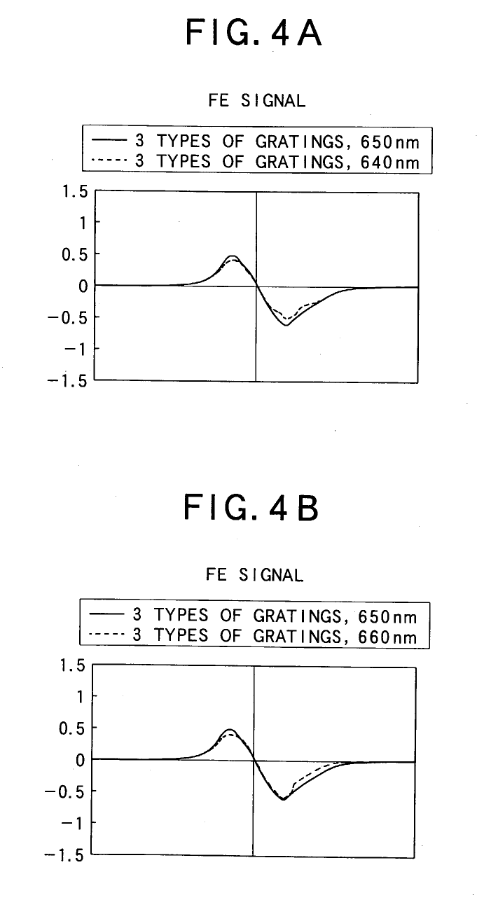

As described above, in this embodiment the grating 5 area comprises eight strip-shaped areas, and these areas are divided into gratings that are optimized for three wavelengths. By using this kind of construction, it is possible to suppress deterioration of the focus operation due to variation in the laser wavelength. In other words, by using the grating 5 shown in FIG. 3, a focus-error signal is obtained that is nearly the same as that obtained when the wavelength is 650 nm, even when the wavelength changes to 640 nm as shown in FIG. 4A. In FIG. 4A, the solid line shows the case when the wavelength is 650 nm, and the dashed line shows the case when the wavelength is 640 nm.

Also, a focus-error signal is obtained that is nearly the same as that obtained when the wavelength is 650 nm, even when the wavelength changes to 660 nm as shown in FIG. 4B. In FIG. 4B, the solid line shows the case when the wavelength is 650 nm, and the dashed line shows the case when the wavelength is 660 nm.

How the effect of variation in the wavelength is reduced in this embodiment will be explained.

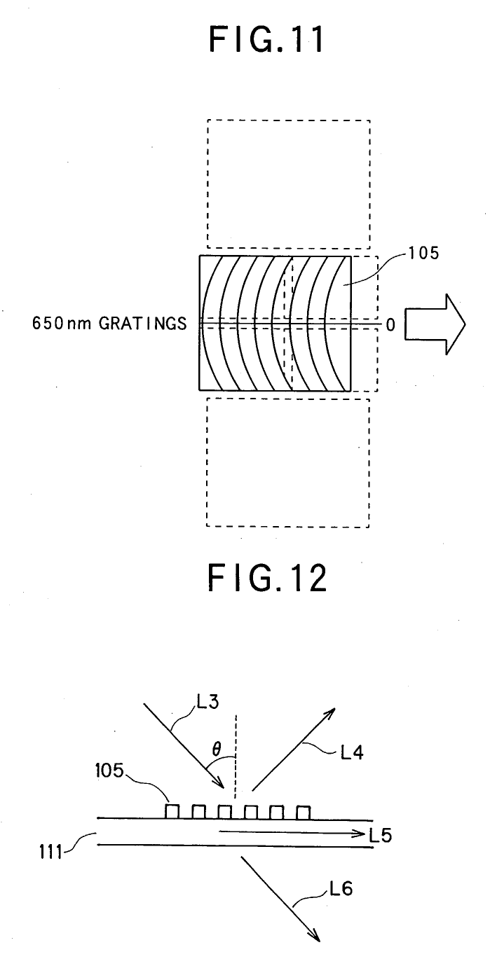

First, FIG. 11 to FIG. 17 will be used to explain the relationship between the variation in the wavelength of light that enters prior grating that was optimized for a short wavelength and the light that is transmitted along the light guide.

FIG. 11 shows a grating that has been optimized for an incident light having a wavelength of 650 nm. This grating is designed by matching the phase of the incident light with the transmitted light, so the grating period changes a little. Normally, this is called a chopped grating.

As shown in FIG. 12, when the light L reflected from the optical disc reaches the grating layer 105, part of the light is reflected by the surface and becomes L4, and another part of the light is transmitted inside the light guide 111 as guided light L5, and the remaining part of the light passes through the grating 105 and light guide 111. The focus-error signal, which is a signal that reads the focal-point position data of the light irradiated on the optical-data recording medium, is generated from the light that enters the light-receiving elements that correspond to light-receiving element F and light-receiving element R, so the focus-error signal is not distorted as long as the input conversion efficiency of the guided light L5 with respect to L3 does not change due to variation in the wavelength of the incident light. Also, since the focus-error signal is not distorted if the conversion efficiency does not change linearly with respect to variations in the disc, or in other words, the angle è between the light L3 and the grating 5, it becomes possible to more accurately and more easily control the position of the objective lens and to control the shape of the spot that is irradiated onto the surface of the disc.

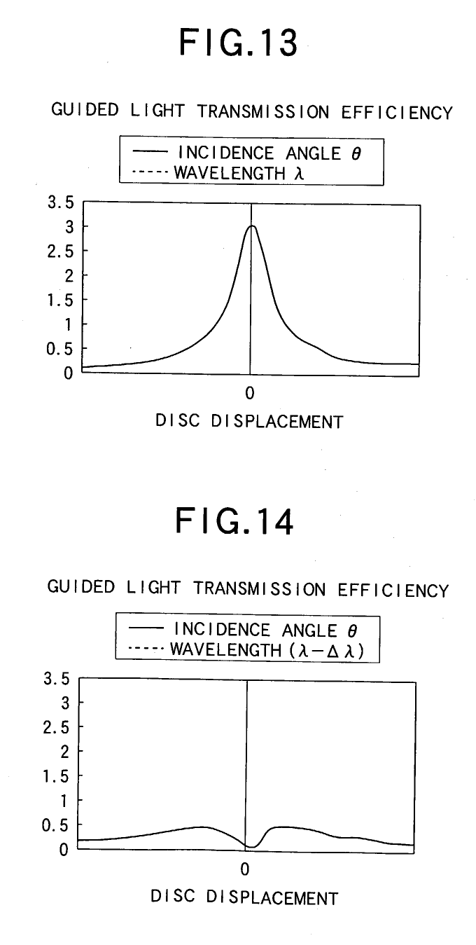

FIG. 13 shows relative values on the vertical axis of the conversion efficiency of the guided light L5 with respect to the reflected light L3 when the angle of the incident light on the grating 105 is è, and the wavelength is ë. The position where the disc displacement is ‘0’ indicates that the incidence angle of L3 is è, and in this case it can be seen that the relative conversion efficiency on the vertical axis is a maximum. That the disc displacement becomes larger from position ‘0’ in FIG. 13 (moves to the right) means that the disc is getting farther from the objective lens, and as a result, it can be seen that the incidence angle è of L3 becomes smaller and the relative conversion efficiency on the vertical axis becomes smaller. Also, that the disc displacement becomes smaller from position ‘0’ in FIG. 13 (moves to the left) means that the disc is getting closer to the objective lens, and as a result, the incidence angle \grave{e} becomes larger, and similarly the relative conversion efficiency on the vertical axis becomes smaller.

In FIG. 14, when the wavelength of the incident light L3 becomes smaller by an amount Ä\ddot{e} from ë (10 nm), the relative conversion efficiency with respect to the disc displacement becomes smaller, and the waveform becomes distorted with respect to the disc displacement.

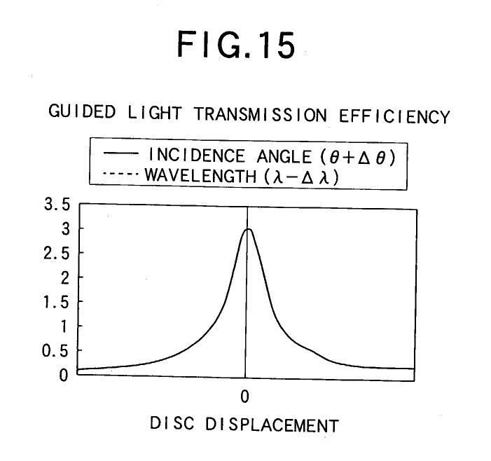

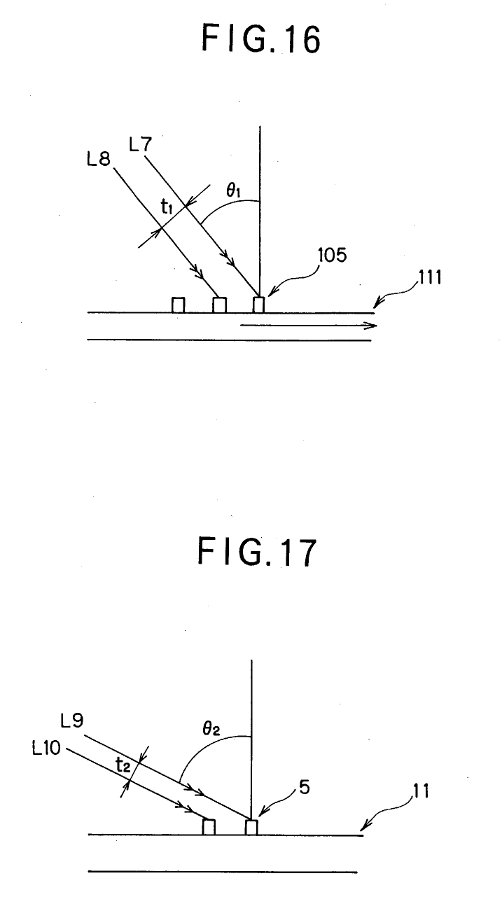

Therefore, it becomes impossible to control the position of the objective lens based on the focus-error signal that utilizes the guided light L5. In other words, it is necessary to change the grating pitch to correspond with the variation in the wavelength. In this case, the wavelength has become shorter, so by making the grating pitch smaller, the input conversion efficiency is improved. Here, FIG. 15 shows test results of when the incidence angle of the incident light L3 with respect to a line normal to direction of the guided light L5 shown in FIG. 12 is increased, and the pitch of the grating 105 is made smaller with respect to the incident light L3. Also, the optical path for this case is shown in FIG. 16 and FIG. 17.

In FIG. 16, the incidence angle between light L7 and light L8 and a line perpendicular to the surface of the grating 105 is è1. As can be seen, in this case, the pitch interval of the grating 105 with respect to the angle è1 is t1. In FIG. 17, the incidence angle between light L9 and light L10 and a line perpendicular to the surface of the grating 105 is è21. As can be seen, in this case, the grating pitch is t2. In other words, t2<t1.

Therefore, the larger the incidence angle is with respect to a line normal to the direction of the guided light L5, the smaller the pitch of the grating 105 is.

Therefore, when the wavelength of the incident light L3 becomes smaller from ë to ë−Äë, the wavelength of the incident light L3 shown in FIG. 12 becomes shorter, so as can be seen from the facts above, the grating pitch can be made small. In order to decrease the pitch of the grating 5, it is inferred that the incidence angle of the incident light L3 can be made larger from è to è+Äè.

The test results from when the incidence angle was increased are shown in FIG. 15. As can be clearly seen from FIG. 15, when the wavelength of the incident light L3 is decreased from ë to ë−Äë, the efficiency of the guided light L5 with respect to the displacement of the disc 1 is improved by decreasing the pitch of the grating 105 to correspond to Äë. In other words, when the wavelength of the light entering the grating 105 becomes smaller, in order to keep the input conversion efficiency of the grating 105 from changing without changing the angle of the incident light, it is possible to suppress variation in the input conversion efficiency by making the pitch of the grating 105 smaller. Also, as was described above and from the test results, it is clear that when the wavelength of the light entering the grating 105 becomes larger, the input conversion efficiency is improved by making the pitch of the grating 105 larger.

FIG. 9 shows the focus-error signal for a wavelength of 650 nm in the case when the grating 105 shown in FIG. 11 is used. There is no essential difference between this embodiment and when grating 105 was used.

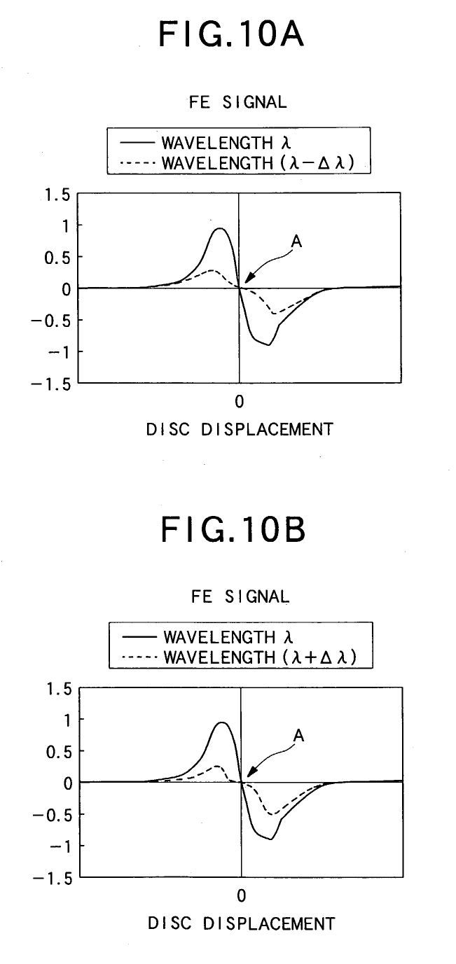

On the other hand, FIG. 10A shows the focus-error signal when the prior grating 105 was used and when there were variations in the wavelength, where the solid line corresponds to a wavelength of 650 nm, and the dashed line corresponds to a wavelength of 640 nm. As shown in FIG. 10A, the solid line (650 nm) corresponds to when the disc displacement is to the left and right centered about the ‘0’ position, and the line to the peak values is for the most part linear. Therefore, it is possible to accurately control the position of the objective lens based on this focus-error signal. However, in the case of the dotted line when 640 nm light enters, the focus-error signal becomes greatly distorted, and it becomes difficult to control the position of the objective lens.

FIG. 10B shows the case when the prior grating 105 was used, and the solid line shows the case when the wavelength is 650 nm, and the dotted line shows the case when the wavelength is 660 nm. As shown in FIG. 10B, in the case of the dotted line when 660 nm light enters, the focus-error signal become greatly distorted as in the case of 640 nm light, and it becomes difficult to control the position of the objective lens.

The focus-error signal (FE) in each of the figures is expressed as FE=(F1+R2+F3)−(R1+F2 +R3). The horizontal axis in each of the figures shows the distance between the disc and the objective lens. Disc displacement ‘0’ on the horizontal axis is the state when the optimal distance between the disc and objective lens. In other words, it is the state when the size of the light spot on the optical disc 1 is a minimum.

As described above, in this embodiment, the percentage of incident light that passes through the grating 5 and is transmitted by the light guide, or in other words, the incidence coupling efficiency, becomes a nearly a constant value when the wavelength is 640 nm, 650 nm or 660 nm. As a result, as shown in FIG. 4A and FIG. 4B, there is hardly any deterioration of the focus-error signal due to variation in the wavelength. Also, it is not shown in the figures, however, a favorable waveform for the focus signal can be obtained for any wavelength between 640 nm and 660 nm. In other words, with this embodiment, when the wavelength of the incident light is within the range 660 nm to 640 nm, there is hardly any deterioration of the focus-error signal of the optical pickup apparatus shown in FIG. 1.

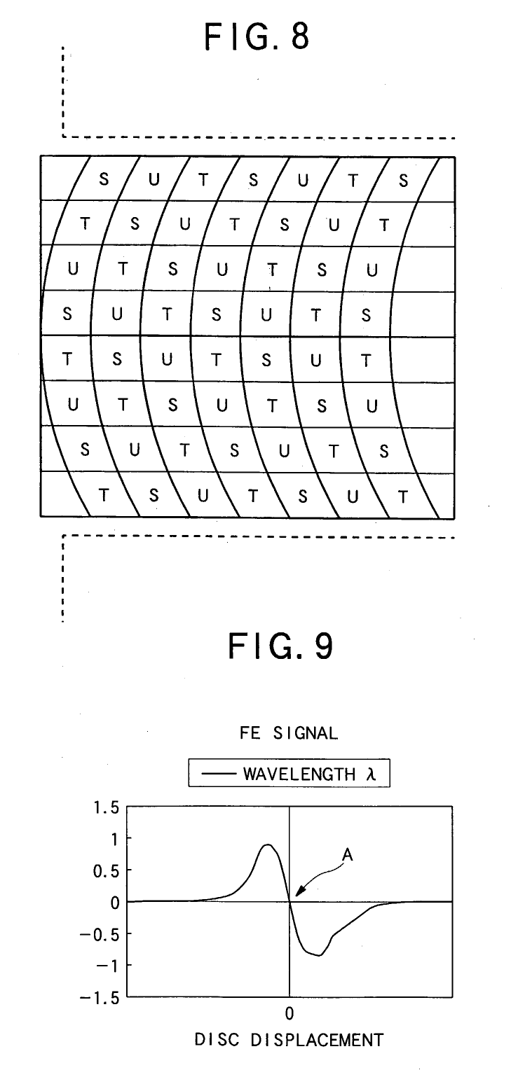

FIG. 8 shows a second embodiment of the invention.

FIG. 8 shows a method of arranging gratings that are optimized for different wavelengths on the same plane, and it shows the case of dividing the grating area into rectangular shapes. There are three types of gratings: grating S for a wavelength of 640 nm, grating T for a wavelength of 650 nm and grating U for a wavelength of 660 nm. The 8 ×8 rectangular grating areas are arranged such that gratings optimized for the same wavelength are not adjacent to each other, and the area of each the grating areas is nearly the same. In this embodiment as well, it was found that it is possible to effectively suppress deterioration of the focus-error signal due to variation of the wavelength of the incident light.

In embodiments 1 and 2, three types of grating patterns were used, however, it is also possible to used N (N is a positive integer) types of grating patterns for the anticipated incident wavelength range. The center value of incident wavelengths was taken to be 650 nm, however, this invention can of course be applied to any light from the infrared region having long wavelengths to the blue range.

Moreover, in these embodiments, results were shown when Äë for the center wavelength 650 nm was from −10 nm to +10 nm, however, from calculation, it was found that even for variation of the wavelength from −15 nm to +15 nm, distortion of the focus-error signal did not hinder control of the objective lens position.

Furthermore, in the second embodiment, the grating areas were rectangular in shape, however, the shape of the areas could be any shape.

According to the present invention, it is possible to suppress distortion of the focus-error signal even when the wavelength of the light source of the light shown onto an optical disc changes due to surrounding temperature or passing of time, and thus it is possible to accurately control the focus.

Also, since the integrated optical device of this invention can be produced using an IC process to integrate the light-receiving elements, light guide and optical coupling means or grating on the same substrate, it not only becomes possible to mass produce the device but also becomes possible to create a device that requires no adjustment. The entire disclosure of Japanese Patent Application No. 2002-29979 filed on Feb. 6, 2002 including the specification, claims, drawings and summary is incorporated herein by reference in its entirety.

What is claimed is:

1. An integrated optical device, which is used in an optical pickup apparatus that receives light reflected by an optical medium, comprising:
an optical coupling device that creates both guided light and transmitted light from said reflected light and that is layered with
a light guide device that transmits said guided light; and wherein
said optical coupling device comprises:
a first optimized device that is optimized for a wavelength of said reflected light;
a second optimized device that is optimized to a wavelength that is longer than said wavelength of said reflected light; and
a third optimized device that is optimized to a wavelength that is shorter than said wavelength of said reflected light.

2. An integrated optical device, which is used in an optical pickup apparatus that receives light reflected by an optical medium, comprising:
an optical coupling device that creates both guided light and transmitted light from said reflected light and that is layered with
a light guide device that transmits said guided light; and wherein
said optical coupling device comprises:
a first optimized device that is optimized for a wavelength of said reflected light;
a second optimized device that is optimized to a plurality of wavelength that is longer than said wavelength of said reflected light; and
a third optimized device that is optimized to a plurality of wavelength that is shorter than said wavelength of said reflected light.

3. The integrated optical device according to claim 1, wherein there is a plurality of said first, second and third optimized devices of said optical coupling device for said reflected light arranged such that adjacent devices differ from each other.

4. The integrated optical device according to claim 1, wherein a plurality of said first, second and third optimized devices of said optical coupling device for said reflected light are formed and arranged such that said three devices are lined up in a direction that crosses the direction that the guided light travels.

5. The integrated optical device according to claim 1, wherein
the interval from said wavelength to the wavelength longer than said wavelength is within 2% of said wavelength; and wherein
the interval from said wavelength to the wavelength shorter than said wavelength is within 2% of said wavelength.

6. The integrated optical device according to claim 1, wherein said first, second and third devices of said optical coupling device for said reflected light are formed in the same layer.

7. The integrated optical device according to claim 1, wherein
said integrated optical device is formed on a semiconductor substrate and further comprises:
a first light-receiving device of receiving said transmitted light; and
a second light-receiving device of receiving the light that is emitted from said light guide for said guided light toward the side of the semiconductor substrate, and is a device for detecting the focal-point position for the light shown on said optical media.

8. The integrated optical device according to claim 7, wherein said first and second light-receiving devices are formed in the same layer.

9. A wavelength variation cancellation method of reducing intensity changes in the signal for detecting focal-point position that occur due to changed in the wavelength of the light reflected by an optical medium and characterized by using a combination of; light that passed trough an optical coupling device that is optimized to a wavelength of said reflected light; light that passed through an optical coupling device that is optimized to a wavelength longer than said wavelength of said reflected light; and light that passed through an optical coupling device that is optimized to a wavelength shorter than said wavelength of said reflected light to generate a signal for detecting said focal-point position.
